(19) United States
(12) Patent Application Publication
(10) Pub. No.: US 2008/0082918 A1
(43) Pub. Date: Apr. 3, 2008

(54) COMPUTER SYSTEM AND CONTROL METHOD THEREOF

(75) Inventor: Sang-yeon HWANG, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/764,974

(22) Filed: Jun. 19, 2007

(30) Foreign Application Priority Data
Sep. 29, 2006 (KR) 2006-96257

(51) Int. Cl. G06F 11/00; G06F 1/26; G06F 3/048

(52) U.S. Cl. 715/700; 713/340

(57) ABSTRACT

A computer system including at least one device; a battery unit which possesses a predetermined battery capacity and supplies power to the device; a monitoring unit which monitors a battery remaining capacity of the battery unit; an alarm informing unit which generates an alarm related to the battery unit; and a controller which sets up an alarm level corresponding to the battery capacity of the battery unit, and controls the alarm informing unit to generate the alarm to inform that the battery unit is short of the battery remaining capacity if the battery remaining capacity of the battery unit monitored by the monitoring unit is smaller than the alarm level.

### CROSS-REFERENCE TO RELATED APPLICATIONS

This application claims the benefit of Korean Patent Application No. 2006-96257, filed in the Korean Intellectual Property Office on Sep. 29, 2006, the disclosure of which is incorporated herein by reference.

### BACKGROUND OF THE INVENTION

1. Field of the Invention

Aspects of the present invention relate to a computer system and a control method thereof and, more particularly, to a computer system and a control method thereof, which includes a battery unit.

2. Description of the Related Art

A portable computer system, such as a laptop computer or personal digital assistant, conventionally employs an alternating current (AC) adaptor (not shown) as a main power source and a battery as an auxiliary power source.

In such a conventional computer system, a present remaining battery level is periodically monitored. If the remaining battery level is lower than a default value or a predetermined value (hereinafter referred to as “alarm level”) set up by a user, an alarm, such as a sound and/or a text message, is generated to inform the user that the battery is running low on power. In the conventional computer system, an operating system sets up an alarm level and generates an informing alarm related to the remaining battery level (hereinafter referred to as “battery alarm”). The operating system generally presets a reference value of the alarm level. Since the battery alarm is designed to prevent data from being lost if the battery is completely discharged, it is the most effective to set the alarm level as the minimum battery capacity required to convert a normal mode into a standby mode. For example, in an operating system such as Microsoft Windows, electric power corresponding to approximately three percent (3%) of the capacity of a fully-charged battery, based on a 3-cell battery (i.e., approximately 0.87 Wh), is set up as the alarm level.

However, in the conventional computer system, the alarm level is preset as, for example, three percent (3%) of a standard battery capacity regardless of the real battery capacity of the battery. Accordingly, if the real battery capacity is different from the standard battery capacity, the preset alarm level is not appropriate. For example, if the conventional computer system employs a high capacity battery, the alarm level can impact the efficiency of using the high capacity battery. In particular, if the alarm level is preset as a specific value determined based on the standard battery capacity regardless of the real battery capacity, the efficiency of using the large capacity battery decreases, since the battery capacity still has power remaining to drive the computer system. Given the trend of increasing battery capacities, it may be a bigger problem that the efficiency of using the battery capacity is lowered. Table 1 shows three percent (3%) alarm levels for each battery capacity and the balances compared with the minimum battery capacity.

TABLE 1

| Battery | | | |
|---|---|---|---|
| Type | Battery Capacity | 3% Alarm Level | Balance |
| 3-Cell | 28.86 Wh | 0.87 Wh | 0 |
| 6-Cell | 57.72 Wh | 1.73 Wh | 98% |
| | | | increased |
| 9-Cell | 86.58 Wh | 2.60 Wh | 119% |
| | | | increased |

As illustrated in Table 1, as the battery capacity increases, the inefficiency of the three percent alarm level also increases.

If the real battery capacity is smaller than the standard battery capacity, when a computer system changes from the normal mode to the standby mode, the battery may be completely discharged, potentially rendering the computer system unstable.

### SUMMARY OF THE INVENTION

Aspects of the present invention provide a computer system and a control method, which can improve the efficiency of using a battery. In particular, the operating time of the computer system can be maximized by generating a battery alarm based on a real battery capacity.

Another aspect of the present invention is to provide a computer system and a control method, which can improve a user's convenience in setting a battery alarm.

Still another aspect of the present invention is to provide a computer system and a control method, which can improve the stability of the system. In particular, when a computer system changes from the normal mode to the standby mode, a battery can be prevented from being completely discharged by generating a battery alarm based on a real battery capacity.

Additional aspects of the present invention will be set forth in part in the description which follows and, in part, will be obvious from the description, or may be learned by practice of the present invention.

According to another aspect of the present invention, a computer system is provided, comprising at least one device; a battery unit having a predetermined battery capacity to supply power to the device; a monitoring unit to monitor a remaining power of the battery unit; an alarm informing unit to generate an alarm related to the battery unit; and a controller to set up an alarm level based on the battery capacity of the battery unit and to control the alarm informing unit to generate the alarm to inform a user that the remaining power of the battery unit is low if the remaining power of the battery unit monitored by the monitoring unit is lower than the alarm level.

According to another aspect of the invention, the controller sets up the alarm level as a ratio of a predetermined remaining power to the battery capacity of the battery unit as the alarm level and compares the alarm level with a ratio of the monitored remaining power to the battery capacity.

According to another aspect of the invention, the predetermined remaining power corresponds to a minimum power amount required for the computer system to move from a normal mode to a standby mode stably.

According to another aspect of the invention, the computer system further comprises a user input unit to receive a user input related to setting the alarm level, wherein the controller sets up the alarm level according to the user input received through the user input unit.

According to another aspect of the invention, the computer system further comprises a display unit and a GUI generation unit to generate a graphical user interface displayed on the display unit, wherein the controller controls the GUI generation unit to generate the graphical user interface to set the alarm level.

According to another aspect of the invention, the graphic user interface comprises an item corresponding to at least one of the battery capacity of the battery unit, the predetermined remaining power, and the alarm level.

According to another aspect of the invention, if the battery capacity of the battery unit changes, the controller sets up the alarm level corresponding to the changed battery capacity again.

According to another aspect of the invention, the alarm informing unit comprises at least one of a message display unit and a sound output unit, and the controller controls the message display unit and/or the sound output unit of the alarm informing unit to display an alarm message and/or to output an alarm sound.

According to another aspect of the present invention, a control method of a computer system comprising at least one device and a battery unit having a predetermined battery capacity and supplying power to the device is provided, the method comprising: setting up an alarm level based on the battery capacity of the battery unit; monitoring a remaining power of the battery unit; and generating an alarm to inform a user that the battery unit is low on power if the monitored remaining power of the battery unit is lower than the alarm level.

According to another aspect of the invention, the setting up of the alarm level comprises setting up a ratio of a predetermined remaining power to the battery capacity as the alarm level, and the generating of the alarm comprises comparing the alarm level with a ratio of the monitored remaining power to the battery capacity.

According to another aspect of the invention, the predetermined battery remaining capacity corresponds to a minimum power amount required for the computer system to move from a normal mode to a standby mode stably.

According to another aspect of the invention, the control method further comprises receiving a user input related to a setting of the alarm level; and setting up the alarm level according to the user input.

According to another aspect of the invention, the setting up the alarm level comprises displaying a graphical user interface to set the alarm level.

According to another aspect of the invention, the graphic user interface comprises an item corresponding to at least one of the battery capacity of the battery unit, a predetermined remaining power, and the alarm level.

According to another aspect of the invention, the control method further comprises setting up the alarm level corresponding to a changed battery capacity again if the battery capacity of the battery unit is changed.

According to an aspect of the invention, the generating the alarm comprises displaying an alarm message and/or outputting an alarm sound.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a configuration of a computer system according to an embodiment of the present invention;

FIGS. 2 and 3 illustrate a graphic user interface (GUI) according to an embodiment of the present invention; and

FIG. 4 is a flow chart illustrating an operation of a computer system according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

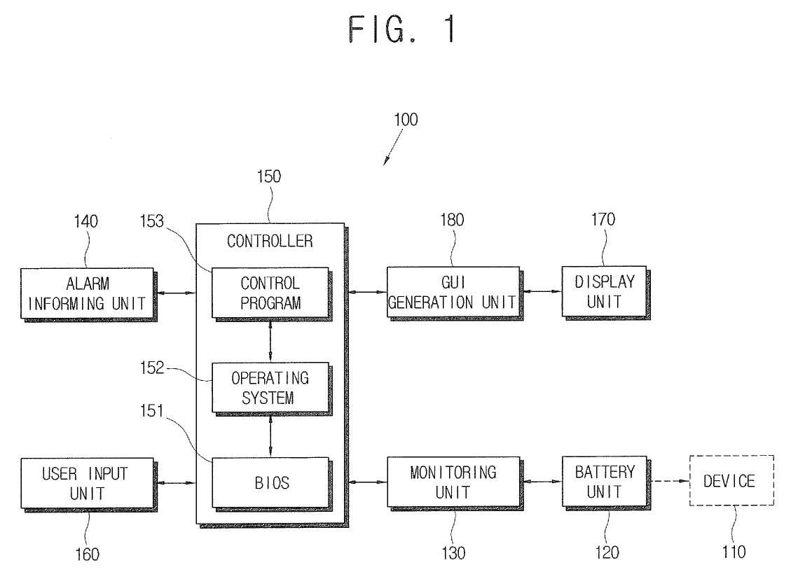

FIG. 1 illustrates a configuration of a computer system 100 according to an embodiment of the present invention. The computer system 100 may be a mobile device, such as a notebook computer, personal digital assistant (PDA), digital camera, personal entertainment device, mobile phone, or multi-function device. The computer system 100 includes at least one device 110 and a battery unit 120 to supply power to the device 110. The device 110 includes a central processing unit (CPU), a random access memory (RAM), a read only memory (ROM), a hard disk drive, a South bridge, a North bridge, a graphic card, a sound card, and a network card. According to other aspects of the present invention, the device 110 may have other components or a different configuration of components. The device 110 may receive power at a predetermined level from the battery unit 120 and performs a predetermined operation.

If AC power is not supplied to the computer system 100, the battery unit 120 provides power to the computer system 100 as one of auxiliary power supplies. The computer system 100 may further include a main power supply (not shown) that converts AC power into DC power at a predetermined level and supplies the converted DC power to the device 110. The battery unit 120 includes a so-called smart battery to provide battery information, such as a battery ID, a battery temperature, a battery current, remaining power, etc., to the device 110.

The computer system 100 further includes a monitoring unit 130 that monitors the remaining power of the battery unit 120; an alarm informing unit 140 that generates an alarm related to the battery unit 120; and a controller 150 that sets up an alarm level corresponding to a real battery capacity of the battery unit 120. According to other aspects of the invention, one or more of the above units may be part of the device 110. The controller 150 may also control the alarm informing unit 140 to generate the alarm to inform the user that the battery unit 120 is low on power if the remaining power of the battery unit 120 monitored by the monitoring unit 130 is lower than the alarm level.

The monitoring unit 130 may include a microcomputer and receives the battery information from the battery unit 120 through communication with the battery unit 120 at predetermined time intervals. The battery information may include a battery capacity, the remaining power, etc.

The controller 150 checks the real battery capacity of the battery unit 120 based on the battery information received from the monitoring unit 130 and sets up the alarm level corresponding to the checked real battery capacity. The controller 150 determines whether to activate an alarm by checking whether the remaining power is lower than the alarm level.

The controller 150 may comprise a basic input output system (BIOS) 151, an operating system 152, and a control program 153. The BIOS 151 transmits the battery information received from the monitoring unit 130 to the operating system 152 in response to a request of the operating system 152. The operating system 152 supports various functions of the control program 153 related to the battery alarm. The control program 153 includes an application program that sets up the alarm level corresponding to a real battery capacity. The control program 153 checks the real battery capacity based on the battery information received from the monitoring unit 130 and sets up the alarm level according to the checked real battery capacity.

The operating system 152 checks whether the remaining power has become lower than the alarm level and controls the alarm informing unit 140 to generate an alarm if the remaining power is lower than the alarm level. According to the specification of Advanced Configuration and Power Interface (ACPI), the operating system 152 compares a ratio of the remaining power to a last fully-charged battery capacity (hereinafter referred to as “remaining battery percentage”) with the alarm level. The operating system 152 calculates the remaining battery percentage with the following formula 1.

Remaining battery percentage=(remaining power/last fully-charged battery capacity)*100[%] [Formula 1]

The unit of the remaining power and the last fully charged battery capacity may be milliwatt [mW] or milliampere [mA].

The operating system 152 receives the last fully charged battery capacity and the remaining power from the monitoring unit 130. The operating system 152 calculates the remaining battery percentage based on the last fully charged battery capacity and the remaining power. The operating system 152 checks whether the calculated remaining battery percentage is lower than the alarm level and takes action depending on the result.

The control program 153 sets up a ratio of a predetermined value (hereinafter referred to as “remaining power setting value”) to the battery capacity of the battery unit 120 as the alarm level so that the remaining power required to generate the alarm can be maintained uniformly regardless of the real battery capacity of the battery unit 120. For example, the remaining power setting value may correspond to a minimum power amount required for the computer system 100 to move from a normal mode to a standby mode stably (hereinafter, the corresponding alarm level is referred to as “alarm level 1”). In an embodiment of the present invention, the remaining power setting value may be approximately 1 Wh.

Two or more alarm levels may be set up. An additional alarm level may be used as an auxiliary alarm. For example, approximately 3 Wh may be set up as another remaining power setting value and an additional alarm level corresponding to 3 Wh is set up (hereinafter referred to as “alarm level 2”). The remaining power setting value may be stored in a designated memory (not shown).

The alarm level may be set up according to the following formula 2. A unit of the alarm level may be a percentage corresponding to the remaining battery percentage.

Alarm level=(remaining power setting value/real battery capacity)*100[%] [Formula 2]

In formula 2, the unit of the remaining power setting value may be milliwatt [mW] or milliampere [mA]. The alarm level is in inverse proportion to the real battery capacity of the battery unit 120: as the real battery capacity becomes larger, the alarm level becomes smaller. Table 2 below shows alarm levels according to formula 2.

TABLE 2

| | Real Battery | Alarm | |
|---|---|---|---|
| Battery Type | Capacity | Level 1 | Power Amount |
| 3-Cell | 28.86 Wh | 3% | approximately 1 Wh |
| 6-Cell | 57.72 Wh | 2% | approximately 1 Wh |
| 9-Cell | 86.58 Wh | 1% | approximately 1 Wh |

As illustrated in table 2, as the real battery capacity increases, the control program 153 dynamically sets up alarm level 1 as 3%, 2% and 1%, respectively.

The user may define the remaining power setting value. The computer system 100 may further include a user input unit 160 to receive user input related to the setting of the alarm level. The control program 153 sets up the alarm level according to the user input received through the user input unit 160. The control program 153 may set up the alarm level by allowing the user to select at least one preset remaining power setting value or to directly input an arbitrary remaining capacity setting value. The user input unit may comprise a keyboard, a mouse, and/or other input device.

The computer system 100 may further include a display unit 170 and a GUI generation unit 180 to generate a graphic user interface displayed on the display unit 170. The control program 153 may control the GUI generation unit 180 to generate a graphical user interface for setting the alarm level. The display unit 170 may comprise a liquid crystal display monitor (not shown) or other type of monitor. The GUI generation unit 180 may be realized by the operating system 152 and a graphic card (not shown).

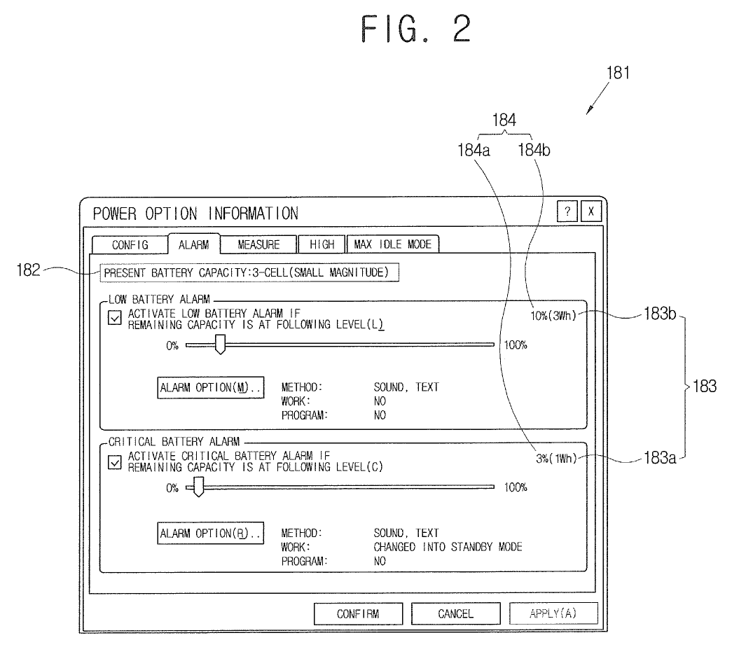

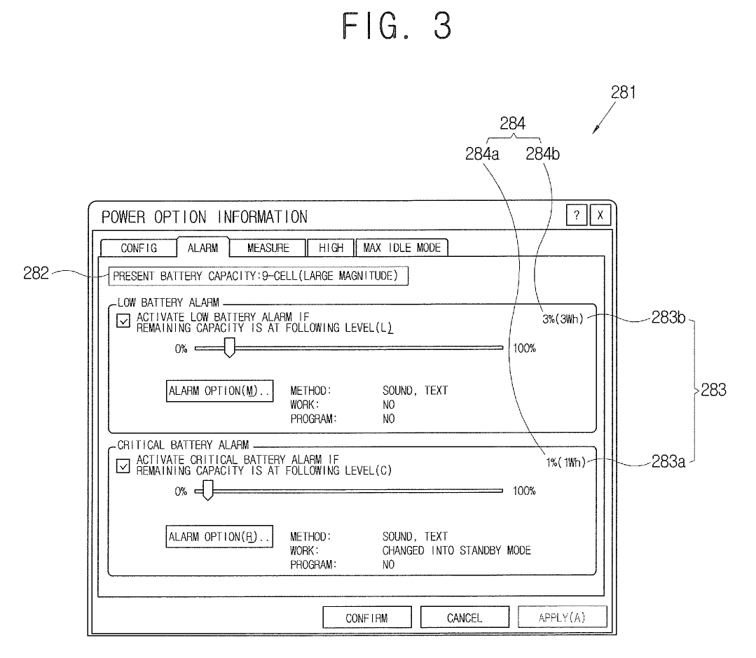

FIGS. 2 and 3 illustrate graphic user interfaces 181 and 281 according to an exemplary embodiment of the present invention. The graphic user interfaces 181 and 281 include first items 182 and 282 to show the battery capacity of the battery unit 120, second items 183 and 283 to show the remaining capacity setting value, and third items 184 and 284 to show the alarm level. For example, the battery capacity of the battery unit 120, such as “3-cell (small magnitude)”, “9-cell (large magnitude)”, etc., may be displayed in the first items 182 and 282. The remaining power setting value, such as “3 Wh”, “2 Wh”, “1 Wh”, etc., may be displayed in the second items 183 and 283. The alarm level, such as “10%”, “3%”, “1%”, etc., may be displayed in the third items 184 and 284. The user can set a battery alarm by referring to a present battery capacity and a present alarm level through the graphic user interface 181 and 281, thereby providing convenience to the user in setting the battery alarm.

The third item 184 or 284 comprises an alarm level 1 184a or 284a and an alarm level 2 184b or 284b. For example, the alarm level 2 184b or 284b may be an auxiliary alarm level to inform the user that the battery unit 120 is running low on power. The alarm level 1 184a or 284a indicates a substantial alarm level to inform the user that the computer system 100 will be entering the standby mode as an emergency measures due to a lack of the remaining power.

If the battery capacity of the battery unit 120 changes, the control program 153 may change the preset alarm level to correspond to the changed battery capacity. For example, if the battery unit 120, which is set to 3% alarm level, changes from a 3-cell battery to a 9-cell battery, the controller 150 changes the alarm level from 3% to 1%.

The alarm informing unit 140 may include at least one of a message display unit (not shown) to display a message and a sound output unit (not shown) to output a sound. The controller 150 controls the message display unit and/or the sound output unit of the alarm informing unit 140 to display an alarm message and/or to output an alarm sound. The message display unit may be realized by the display unit 170.

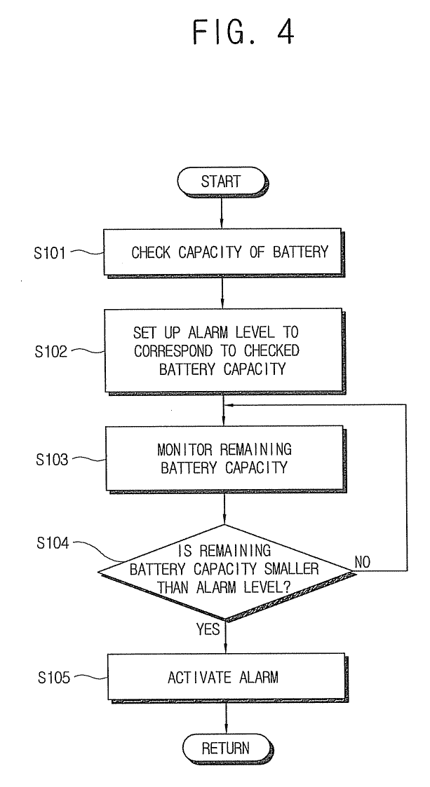

FIG. 4 is a flow chart illustrating an operation of the computer system 100 according to an embodiment of the present invention. First, the battery capacity of the battery unit 120 is checked (S101). Then, the alarm level is set up to correspond to the checked battery capacity (S102). Next, the remaining power is checked at a predetermined time interval (S103). Next, it the remaining power is compared to a preset alarm level (S104). In operation S104, if the remaining battery capacity is not smaller than the preset alarm level, the operation returns to operation S103.

In operation S104, if the remaining battery capacity is lower than the preset alarm level, an alarm is activated (S105). In addition, the battery capacity of the battery unit 120 is checked to determine if the battery capacity has changed. If the battery capacity of the battery unit 120 has changed, the operation S104 may include a stage to set up the alarm level again to correspond to the changed battery capacity.

According to aspects of the present invention, the efficiency of using a battery can be improved. The amount of time of using a battery-powered computer system can be maximized by generating an alarm based on the real capacity of the battery unit.

Further, according to aspects of the present invention, a user can set the battery alarm by referring to a present battery capacity and a present alarm level through a graphical user interface, thereby providing a convenience to the user in setting the battery alarm.

Further, according to aspects of the present invention, there are provided a computer system and a control method thereof, which can improve the stability of a computer system. In particular, the battery can be prevented from being completely discharged while the computer system driven by the battery moves from a normal mode to a standby mode by generating the battery alarm based on the real capacity of the battery.

Although a few embodiments of the present invention have been shown and described, it would be appreciated by those skilled in the art that changes may be made in this embodiment without departing from the principles and spirit of the invention, the scope of which is defined in the appended claims and their equivalents.

What is claimed is:

1. A computer system, comprising:
at least one device;
a battery unit having a predetermined battery capacity to supply power to the device;
a monitoring unit to monitor remaining power of the battery unit;
an alarm informing unit to generate an alarm related to the battery unit; and
a controller to set up an alarm level based on the battery capacity of the battery unit and to control the alarm informing unit to generate the alarm to inform a user that the remaining power of the battery unit is low if the remaining power of the battery unit monitored by the monitoring unit is lower than the alarm level.

2. The computer system according to claim 1, wherein the controller sets up the alarm level as a ratio of a predetermined remaining power to the battery capacity of the battery unit and compares the alarm level with a ratio of the monitored remaining power to the battery capacity.

3. The computer system according to claim 2, wherein the predetermined remaining power corresponds to a minimum power amount required for the computer system to move from a normal mode to a standby mode stably.

4. The computer system according to claim 1, further comprising:
a user input unit to receive a user input related to setting the alarm level;
wherein the controller sets up the alarm level according to the user input received through the user input unit.

5. The computer system according to claim 4, further comprising:
a display unit; and
a GUI generation unit to generate a graphical user interface displayed on the display unit,
wherein the controller controls the GUI generation unit to generate the graphical user interface to set the alarm level.

6. The computer system according to claim 5, wherein the graphical user interface comprises an item corresponding to at least one of the battery capacity of the battery unit, a predetermined remaining power, and the alarm level.

7. The computer system according to claim 1, wherein if the battery capacity of the battery unit changes, the controller sets up the alarm level corresponding to the changed battery capacity again.

8. The computer system according to claim 1, wherein:
the alarm informing unit comprises at least one of a message display unit and a sound output unit; and
the controller controls the message display unit and/or the sound output unit of the alarm informing unit to display an alarm message and/or to output an alarm sound.

9. A control method of a computer system comprising at least one device and a battery unit having a predetermined battery capacity and supplying power to the device, the method comprising:
setting up an alarm level based on the battery capacity of the battery unit;
monitoring a remaining power of the battery unit; and
generating an alarm to inform a user that the battery unit is low on power if the monitored remaining power of the battery unit is lower than the alarm level.

10. The control method according to claim 9, wherein:
the setting up of the alarm level comprises setting up the alarm level as a ratio of a predetermined remaining power to the battery capacity; and
the generating of the alarm comprises comparing the alarm level with a ratio of the monitored battery remaining capacity to the battery capacity.

11. The control method according to claim 10, wherein the predetermined remaining power corresponds to a minimum power amount required for the computer system to move from a normal mode to a standby mode stably.

12. The control method according to claim 9, further comprising:
receiving a user input related to a setting of the alarm level; and
setting up the alarm level according to the user input.

13. The control method according to claim 12, wherein the setting up the alarm level comprises displaying a graphical user interface to set the alarm level.

14. The control method according to claim 13, wherein the graphical user interface comprises an item corresponding to at least one of the battery capacity of the battery unit, a predetermined remaining power, and the alarm level.

15. The control method according to claim 9, further comprising setting up the alarm level corresponding to a changed battery capacity again if the battery capacity of the battery unit changes.

16. The control method according to claim 9, wherein the generating the alarm comprises displaying an alarm message and/or outputting an alarm sound.

17. The control method according to claim 9, wherein the setting of the alarm level comprises setting a plurality of alarm levels, each corresponding to a different ratio of a predetermined remaining power to the battery capacity.

18. The computer system according to claim 1, wherein the controller sets up a plurality of alarm levels, each corresponding to a different ratio of a predetermined remaining power to the battery capacity.

19. The computer system according to claim 2, wherein the predetermined remaining power is approximately 1 Wh.

20. A computer system comprising:
a battery monitoring unit to monitor the remaining power of a battery coupled to the computer system and to compare the remaining power with an alarm level varying based upon a ratio of a predetermined remaining power level to the capacity of the battery; and
an alarm generation unit to generate an alarm if the result of the battery monitoring unit's comparison indicates that the percentage of remaining power is lower than the alarm level.

21. The computer system according to claim 20, wherein the predetermined remaining power level is determined by a user.

22. The computer system according to claim 20, further comprising a plurality of alarm levels, each alarm level corresponding to a ratio of a different predetermined remaining power level to the battery capacity.

23. A mobile device comprising:
a monitor to monitor a remaining power of a battery; and
an alarm generator to generate an alarm if a ratio of remaining power to the capacity of the battery, which varies based on the capacity, is lower than an alarm level.

24. The method according to claim 23, wherein the ratio is determined to maintain a predetermined remaining power to be substantially constant.
